(19) United States
(12) Patent Application Publication
(10) Pub. No.: US 2022/0211083 A1
(43) Pub. Date: Jul. 7, 2022

(54) DUSTING FLOUR COMPOSITION

(71) Applicant: NISSHIN SEIFUN WELNA INC, Tokyo (JP)

(72) Inventors: Takashi ITO, Chuo-ku (JP); Ryosuke FUJIMURA, Chuo-ku (JP); Souichiro HIWATASHI, Chuo-ku (JP)

(73) Assignee: NISSHIN SEIFUN WELNA INC, Tokyo (JP)

(21) Appl. No.: 17/604,323

(22) PCT Filed: Apr. 18, 2019
(86) PCT No.: PCT/JP2019/016603

§ 371 Date: Oct. 15, 2021

(51) Int. Cl. A23L 7/157; A23L 5/10; A23P 20/12; A23P 20/15; A23L 13/00

(52) U.S. Cl. CPC A23L 7/157; A23L 5/11; A23V 2002/00; A23P 20/15; A23L 13/03; A23P 20/12

(57) ABSTRACT

Provided is a dusting flour composition which is useful for improving the adhesion between a food ingredient and batter and maintaining the texture of the coating of fried food products after cooking. The dusting flour composition contains 5 mass % or more of a modified wheat flour, in which a viscosity of a 10 mass % aqueous suspension of the modified wheat flour is 1,000 mPa·s or less when the aqueous suspension is warmed to 85° C. and then cooled to 25° C., and the dispersibility of the aqueous suspension is 90% or less when the aqueous suspension is warmed to 85° C., then cooled to 25° C., and subsequently allowed to stand for 24 hours.

### TECHNICAL FIELD

The present invention relates to a dusting flour composition used in the production of fried food products.

### BACKGROUND ART

Wheat flour is used as a raw material powder of dough for breads and noodles and batter for deep-fried food products, and as a food material such as a base material for sauces. Further, in the production of dough for breads and noodles, wheat flour is used as a powder for preventing the dough from attaching to the hands and tools. Since wheat flour is likely to be non-uniformly mixed to form crumbs and is likely to be sticky when mixed with water, workability is not necessarily good as a food material. On the other hand, the wheat flour once mixed with water would be better to be used in cooking quickly. Otherwise, the obtained food products may be hardened or have a gritty texture.

Patent Literature 1 describes that a soft wheat flour containing a predetermined amount of powder having a specific particle size has good workability due to less formation of lumps and less scattering of powders. Patent Literature 2 describes that a granulated wheat flour having good workability due to less formation of lumps and less scattering of powders can be obtained by granulating a raw material powder containing wheat flour and water under non-heating conditions. Patent Literature 3 describes that dehydration of wheat flour and subsequent heat treatment at 100° C. or more enables obtaining a powder having a non-adhesive property and smooth texture when the wheat flour is heated by being dispersed in water. Patent Literature 4 describes that a modified wheat flour obtained by subjecting a raw material wheat flour to heat-moisture treatment or dry heat treatment having an RVA peak viscosity from 3,500 to 7,000 mPas and a gelatinization onset temperature of at least 10° C. lower than that of the raw material wheat flour has good dispersibility in water and good workability and is suitable as a coating for deep-fried food. Patent Literatures 5 to 9 describe that a heat-moisture-treated wheat flour having a specific particle size, degree of gelatinization, and viscosity is used as a wheat flour for bakeries, for batter for deep-fried food products, for sauces, or for okonomiyaki.

### CITATION LIST

### Patent Literature

Patent Literature 1: JP-A-2014-103860

Patent Literature 2: JP-A-2014-200208

Patent Literature 3: JP-A-2013-76090

Patent Literature 4: WO 2017/135353

Patent Literature 5: JP-B-5069939

Patent Literature 6: JP-B-5069885

Patent Literature 7: JP-B-5069886

Patent Literature 8: JP-B-5069969

Patent Literature 9: JP-B-5069887

### DISCLOSURE OF THE INVENTION

### Technical Problem

The present invention relates to a dusting flour composition used in the production of fried food products. More in detail, the present invention relates to a dusting flour composition which improves the adhesion between a food ingredient and batter in the production of fried food products and contributes to maintain a crispy texture of a fried coating.

### Solution to Problem

The present invention provides a dusting flour composition, comprising:

5 mass % or more of a modified wheat flour, wherein

a viscosity of a 10 mass % aqueous suspension of the modified wheat flour is 1,000 mPa·s or less when the aqueous suspension is warmed to 85° C. and then cooled to 25° C., and a dispersibility of the aqueous suspension is 90% or less when the aqueous suspension is warmed to 85° C., then cooled to 25° C., and subsequently allowed to stand for 24 hours.

The present invention also provides a method for producing a fried food product, comprising attaching the dusting flour composition to a food ingredient, subsequently attaching batter to the food ingredient, and then frying the food ingredient.

The present invention also provides use of a modified wheat flour in production of a dusting flour composition, wherein

the dusting flour composition comprises 5 mass % or more of the modified wheat flour,

a viscosity of a 10 mass % aqueous suspension of the modified wheat flour is 1,000 mPa·s or less when the aqueous suspension is warmed to 85° C. and then cooled to 25° C., and a dispersibility of the aqueous suspension is 90% or less when the aqueous suspension is warmed to 85° C., then cooled to 25° C., and subsequently allowed to stand for 24 hours.

### Advantageous Effects of Invention

The dusting flour composition of the present invention improves the adhesion between a food ingredient and batter in the production of fried food products. The dusting flour composition of the present invention also serves to maintain a crispy texture of the fried coating. Therefore, use of the dusting flour composition of the present invention in the production of fried food products can improve the appearance and texture of the obtained fried food products.

### DESCRIPTION OF EMBODIMENTS

Coated fried food products have a problem in that the food ingredient shrinks or deforms by heating and the coating is thereby peeled off from the food ingredient during or after cooking by heating. To address this problem, conventionally, the food ingredient is dusted with flour in advance, then attached with batter and cooked so that the food ingredient and the batter can closely adhere to each other. In the field of the production of fried food products, such flour that is attached to the food ingredient before attaching the batter is referred to as dusting flour. Usually, flour mainly containing wheat flour or starch is used as the dusting flour. The dusting flour not only improve the adhesion between the food ingredient and the batter, but also prevents the transfer of the moisture of the food ingredient before frying to the batter. On the other hand, when the food ingredient and the coating are closely adhered to each other in the fried food products after cooking, the moisture of the food ingredient is likely to be transferred to the coating, and thus, the crispy texture of the coating is likely to be lost with the elapse of time. This tendency is significant in the case of storing the food products after frying at a low temperature.

Wheat flour contains crystallized starch particles and enzymes and wheat proteins are present around the starch particles. When wheat flour is heated under the presence of moisture, the starch particles in the wheat flour are swollen and their crystal structures collapse, so that they can retain more moisture. On the other hand, when the wheat flour once heated is cooled, the starch releases the moisture and is recrystallized. This crystal structure formed by recrystallization differs from the crystal structure before heating, and thus the characteristics of the starch are different before and after heating and cooling. When the moisture is present, the protein in the wheat flour changes its structure due to increased hydrogen bonding or hydrolysis, and is irreversibly denatured by heating.

It seemed that the structures and characteristics of the starch and protein contained in wheat flour as well as the changes of the structures and characteristics caused by the addition of moisture to the wheat flour or heating contribute to the characteristics such as the moisture penetration rate and amount of moisture retained of the wheat flour, and the texture of the dough after heating. Thus, the present inventors investigated the behavior of aqueous suspensions of wheat flour under various conditions and examined the suitability as a dusting flour. As a result, the present inventors found that a wheat flour modified such that the viscosity of an aqueous suspension of the wheat flour after heating and then cooling the suspension can be a predetermined value and the dispersibility of the suspension after a predetermined time elapsed from the cooling can be a predetermined value has excellent characteristics when used as the dusting flour.

Therefore, the present invention provides a dusting flour composition which contains a modified wheat flour suitable as a component of the dusting flour for production of fried food products. The modified wheat flour has the following characteristics when prepared into a 10 mass % aqueous suspension of the modified wheat flour: the viscosity of the aqueous suspension is 1,000 mPa·s or less when the aqueous suspension is warmed to 85° C. and then cooled to 25° C., and the dispersibility of the aqueous suspension is 90% or less when the aqueous suspension is warmed to 85° C., then cooled to 25° C., and subsequently allowed to stand for 24 hours. Hereinafter, the modified wheat flour having the above predetermined viscosity and dispersibility used in the dusting flour composition of the present invention (hereinafter, simply also referred to as the composition of the present invention) is also referred to as the modified wheat flour of the present invention.

As used herein, the 10 mass % aqueous suspension of the wheat flour (including modified wheat flour) refers to a suspension containing 10 mass % of the wheat flour obtained by suspending the wheat flour in water. As used herein, the viscosity of the aqueous suspension of the wheat flour is the viscosity of the suspension measured in accordance with the Japanese Industrial Standard JISZ 8803:2011 “Methods for viscosity measurement of liquid” using a rotational viscometer in the conditions of from 12 to 30 rpm. Preferably, the viscosity of the aqueous suspension of the wheat flour measured herein is a value obtained by applying predetermined treatments (heating, cooling, allowing to stand, etc.) to the aqueous suspension of the wheat flour prepared at 25° C., if necessary, and then measuring the viscosity thereof by the above-mentioned means.

In the 10 mass % aqueous suspension of the modified wheat flour of the present invention, the viscosity when the aqueous suspension is warmed to 85° C. and then cooled to 25° C. is only required to be 1,000 mPa·s or less, preferably 800 mPa·s or less, more preferably 600 mPa·s or less, and further preferably 400 mPa·s or less. With the viscosity more than 1,000 mPa·s, the crispness and meltability in the mouth of the coating of the fried food products obtained using the batter of the present invention are reduced. In the 10 mass % aqueous suspension of the modified wheat flour of the present invention, the viscosity when the aqueous suspension is warmed to 85° C. and then cooled to 25° C. is preferred as low as possible, and the lower limit of the viscosity is not particularly limited. Preferably, the viscosity may be below the limit of the measurement using a rotational viscometer by the above measurement method, that is, such a low value that no numerical value can be measured by a rotational viscometer, for example, 10 mPa·s or less.

The dispersibility of the aqueous suspension of wheat flour as used herein refers to a proportion of wheat flour particles dispersed in the suspension (wheat flour particles maintaining a state of being suspended in water without floating or settling). High dispersibility means that the wheat flour particles are easily dispersed in water and separation from water due to floating and sedimentation hardly occurs. The dispersibility of the aqueous suspension of the wheat flour as used herein is a value calculated by the following procedure: the aqueous suspension of the wheat flour is transferred into a container such as a graduated cylinder capable of visually measuring the capacity from outside, which is allowed to stand for a predetermined time, and then the boundary between the turbid part containing the wheat flour and the other transparent part in the suspension is visually measured, the volume of the turbid part is measured based on the boundary, and subsequently, the dispersibility is calculated according to the following equation based on the volume.

Dispersibility (%)=volume of turbid part/total volume×100

(Total volume=volume of turbid part+volume of transparent part)

Preferably, the dispersibility of the aqueous suspension of the wheat flour measured herein is a value obtained by applying predetermined treatments (heating, cooling, etc.) to the aqueous suspension of the wheat flour prepared at 25° C., if necessary, then allowing to stand for 24 hours, and measuring the dispersibility thereof by the above-mentioned means.

In the 10 mass % aqueous suspension of the modified wheat flour of the present invention, the dispersibility when the aqueous suspension is warmed to 85° C., then cooled to 25° C., and subsequently allowed to stand for 24 hours is only required to be 90% or less, preferably 80% or less, more preferably 70% or less, and further preferably 65% or less. With the dispersibility more than 90°, the attachability of the coating and the crispness of the coating of the fried food products obtained using the composition of the present invention are reduced.

Preferably, in the 10 mass % aqueous suspension of the modified wheat flour of the present invention, the range of the dispersibility when the aqueous suspension is warmed to 85° C., then cooled to 25° C., and subsequently allowed to stand for 24 hours is from 10 to 90%, preferably from 10 to 80%, more preferably from 15 to 70%, and further preferably from 20 to 65%.

The average particle size of the modified wheat flour of the present invention is preferably less than 150 μm, more preferably from 15 to 120 μm, and more preferably from 20 to 100 μm from the viewpoint of obtaining an appearance equivalent to the usual wheat flour. As used herein, the average particle size of the wheat flour refers to a volume average particle size measured by a laser diffraction scattering method. As an apparatus for measuring the average particle size, a commercially available laser diffraction particle size distribution analyzer, for example, Microtrac MT3000 II (NIKKISO CO., LTD.) can be used.

In the modified wheat flour of the present invention, the degree of gelatinization is preferably 12% or less, more preferably 10% or less, and further preferably 9% or less. When the degree of gelatinization of the modified wheat flour is too high, the workability in cooking may be reduced or the crispness of the obtained coating of the fried food products may be reduced. As used herein, the degree of gelatinization of the wheat flour refers to a degree of gelatinization measured by a β-amylase pullulanase (BAP) method.

The modified wheat flour of the present invention is only required to have a moisture content equivalent to the usual wheat flour. The moisture content of wheat flour in a normal environment (an environment with the humidity from about 20 to 90%) is from about 10 to 14 mass %. Thus, the moisture content of the modified wheat flour is preferably from 10 to 14 mass %, and more preferably from 11 to 13 mass %. As used herein, the moisture content of the wheat flour refers to a value determined from a change in mass of the wheat flour dried at 135° C. for 1 hour as compared to that before drying.

The modified wheat flour of the present invention can be produced by subjecting raw material wheat flour to modification treatment in such a treatment condition that the wheat flour after modification may have a viscosity and dispersibility of the above predetermined value. The type of the raw material wheat flour is not particularly limited, and hard wheat flour, moderate wheat flour, soft wheat flour, durum flour, and the like can be used. Among them, soft wheat flour is preferred. The moisture content of the raw material wheat flour to be subjected to the modification treatment is preferably from 10 to 14 mass %, and more preferably from 11 to 13 mass %. If necessary, the raw material wheat flour may be conditioned in advance so that the moisture content can be preferably from 10 to 14 mass %, and more preferably from 11 to 13 mass %. The degree of gelatinization of the raw material wheat flour is not higher than the above-mentioned modified wheat flour of the present invention, and is preferably 12% or less, more preferably 10% or less, and further preferably 9% or less.

Examples of the means for the modification treatment of the raw material wheat flour include heat treatment and chemical treatment. In terms of the remaining of the components such as a reagent in the obtained modified wheat flour, heat treatment is preferred. The heat treatment may be either heat-moisture treatment or dry heat treatment. However, the presence of much moisture upon heat treatment may gelatinize the heat-treated wheat flour and reduce the workability. On the other hand, the loss of moisture of the wheat flour upon heat treatment may cause browning of the wheat flour and thus is not preferred.

Therefore, for the heat treatment for obtaining the modified wheat flour of the present invention, the heat treatment is preferred under such conditions that the modified wheat flour after heating can retain the moisture content equivalent to the raw material wheat flour without excessively increasing or losing the moisture content of the raw material wheat flour during heating. For example, it is preferred to prepare the modified wheat flour having a moisture content of from 10 to 14 mass % by heating raw material wheat flour having a moisture content of from 10 to 14 mass % in an environment in which the moisture is not scattered by evaporation and the like (e.g., sealing). If necessary, heating may be performed while stirring the raw material wheat flour. Preferably, for the heat treatment of the raw material wheat flour, the raw material wheat flour is put into a container capable of sealing vapors (e.g., sealed bag, kiln, capsule) and sealed, and then the raw material wheat flour is heated with the container, preferably while stirring. When the raw material wheat flour is heated under sealed conditions, the moisture evaporated from the wheat flour condensed again in the wheat flour, and thus, the moisture content in the wheat flour after heating is substantially identical to that before heating or only slightly reduced. On the other hand, methods such as directly subjecting the wheat flour to heat wave and hot air, and roasting are not preferred because the moisture of the wheat flour is evaporated and removed. The raw material wheat flour is preferably heated without adding moisture other than the moisture inherent in the raw material wheat flour upon heating of the raw material wheat flour. However, as long as the moisture amount of the modified wheat flour after heating is maintained within the above-mentioned range, the addition of moisture to the raw material wheat flour is acceptable.

In the heat treatment, the temperature of the heating is only required to be from 70 to 170° C., preferably from 80 to 150° C., more preferably from 90 to 140° C., and further preferably from 90 to 130° C., as the product temperature of the wheat flour. The time of the heating is only required to be for from 10 to 80 minutes, preferably from 15 to 70 minutes, more preferably from 15 to 65 minutes, further preferably from 15 to 60 minutes, further preferably from 20 to 60 minutes, and further preferably from 30 to 60 minutes. The heat treatment under the sealed conditions described above can be carried out using, for example, a commercially available sealed heated mixing apparatus (for example, a rocking dryer manufactured by AICHI ELECTRIC CO., LTD.).

When the raw material wheat flour is heated in a presence of water upon heating of the raw material wheat flour, the degree of gelatinization may be increased. Thus, the heating temperature and moisture content of the raw material wheat flour are preferably adjusted such that the degree of gelatinization of the wheat flour after heating falls within a range of the degree of gelatinization of the above-mentioned modified wheat flour of the present invention, upon heat treatment of the aforementioned raw material wheat flour.

If necessary, preparation may be performed by grinding or classifying the obtained wheat flour after heating to have the above-mentioned average particle size of the modified wheat flour of the present invention. However, in the aforementioned heat treatment for obtaining the modified wheat flour of the present invention, wheat flours are hardly granulated sticking to each other, and thus the grinding or the classification is basically not required.

The modified wheat flour of the present invention obtained by the aforementioned procedure has excellent characteristics as the dusting flour in the production of fried food products. The fried food products produced using the dusting flour composition containing the modified wheat flour of the present invention improves the adhesion between the food ingredient and the batter in the production of fried food products and maintains the crispy texture of the coating in the fried food products after cooking. Therefore, high quality-fried food products having a good appearance and a good texture can be produced by using the modified wheat flour of the present invention as a component of the dusting flour composition.

The dusting flour composition of the present invention is a composition containing the modified wheat flour of the present invention. The content of the modified wheat flour of the present invention in the composition of the present invention is only required to be 5 mass % or more, and is preferably from 5 to 60 mass %, more preferably from 5 to 30 mass %, further preferably from 10 to 30 mass %, and further preferably from 15 to 25 mass %.

Examples of components other than the modified wheat flour of the present invention contained in the dusting flour composition of the present invention include, but are not limited to, cereal flours other than the modified wheat flour of the present invention; starches; saccharides such as dextrin, starch syrup, and sugar alcohol; egg powder other than egg white powder or proteins; thickening agents; seasonings such as salts and amino acids; spices; fragrances; and fats and oils. Examples of the cereal flours other than the modified wheat flour of the present invention include wheat flours other than the modified wheat flour such as wheat flours not subjected to modification treatment, dry heat-treated wheat flour, and gelatinized wheat flour; barley flour, rye flour, rice flour, corn flour, sorghum flour, and soybean flour. Examples of the starches include starches such as potato starch, tapioca starch, corn starch, waxy corn starch, and wheat starch; and modified starches thereof (gelatinized starch, etherified starch, esterified starch, acetylated starch, and crosslinked starch). The composition containing the modified wheat flour of the present invention may contain any one component selected from the group consisting of the cereal flours other than the modified wheat flour of the present invention, starches, and other raw materials mentioned above alone, or may contain two or more thereof. The content of the components other than the modified wheat flour of the present invention contained in the composition is only required to be the balance of the modified wheat flour of the present invention, that is, 95 mass % or less. Preferably, the dusting flour composition of the present invention contains one or more selected from the group consisting of cereal flours other than the modified wheat flour of the present invention or starches, and the content thereof is 95 mass % or less, preferably from 40 to 95 mass %, more preferably from 70 to 95 mass %, further preferably from 70 to 90 mass %, and further preferably from 75 to 85 mass % in total. More preferably, the cereal flours other than the modified wheat flour of the present invention or starches contain one or more selected from the group consisting of unmodified starch, rice flour, and barley flour, and the total content of the unmodified starch, rice flour, and barley flour in the dusting flour composition of the present invention is preferably from 20 to 50 mass %.

The fried food products can be produced by attaching the dusting flour composition of the present invention to a food ingredient, subsequently attaching batter to the food ingredient, and then frying the food ingredient. The food ingredient of the fried food products is not particularly limited and examples thereof include livestock meat such as chicken, pork, beef, lamb, and goat; seafood such as cuttlefish, shrimp, and jack mackerel; and vegetables. The composition of the present invention is preferably applied to a food ingredient which is likely to be shrunk by heating, such as meat and seafood, from the viewpoint of improving the adhesion between the food ingredient and the coating. The type of the fried food products produced using the composition of the present invention as the dusting flour is not particularly limited, as long as they are coated fried food products, and examples thereof include karaage, French fries, tempura, or fritters, braded fried foods.

When the dusting flour composition of the present invention is used in the production of the fried food products, the composition of the present invention in powder form is directly attached to the food ingredient. If necessary, the food ingredient may be seasoned before attaching the composition of the present invention. Thereafter, the batter is appropriately attached to the food ingredient to which the composition of the present invention has been attached. The batter may be either powdered batter (breader) or liquid batter (batter liquid). For the type of the batter to be attached, an appropriate one may be used depending on the type of fried food products to be produced. Examples of the breader include, but are not limited to, bread crumbs, karaage powder, cereal flour, and starch powder. Examples of the batter liquid include, but are not limited to, egg liquid, batter liquid for tempura or breaded fried food, and batter liquid for karaage.

Subsequently, the food ingredient to which the batter has been attached is fried, whereby a fried food product can be produced. Frying may be performed according to an ordinary method such as deep frying with a large amount of oil or frying with a small amount of oil.

### EXAMPLES

Next, the present invention will be described further specifically by way of examples, but the present invention is not limited only to the following examples.

### Reference Example 1

In the following examples, the viscosity and the dispersibility of the wheat flour were measured by the following methods.

### [Measurement of Viscosity of Wheat Flour]

50 g of wheat flour was put in a small pot whose tare was measured, 450 mL of water at 25° C. was added thereto, and then the mixture was stirred with a stirrer until uniformly dispersed to obtain an entirely uniform dispersion liquid. Water was added to the dispersion liquid until the mass of the small pot whose tare was subtracted reached 500 g, and the mixture was entirely uniformly stirred. The small pot was heated and the product temperature was warmed to 85° C. while stirring the dispersion liquid. After the temperature was reached 85° C., the small pot was put in an ice bath, and the dispersion liquid was cooled to 25° C. Subsequently, to compensate for the evaporated moisture, water (25° C.) was added to the dispersion liquid until the mass of the small pot whose tare was subtracted reached 500 g, and the mixture was entirely uniformly stirred. The viscosity of the obtained dispersion liquid was measured using a B-type viscometer in the conditions of 25° C. and from 12 to 30 rpm.

[Measurement of Dispersibility of Wheat Flour]

50 g of wheat flour was put in a small pot whose tare was measured, 450 mL of water at 25° C. was added thereto, and then the mixture was stirred with a stirrer until uniformly dispersed to obtain an entirely uniform dispersion liquid. Water was added to the dispersion liquid until the mass of the small pot whose tare was subtracted reached 500 g, and the mixture was entirely uniformly stirred. The small pot was heated and the product temperature was warmed to 85° C. while stirring the dispersion liquid. After the temperature was reached 85° C., the small pot was put in an ice bath, and the dispersion liquid was cooled to 25° C. Subsequently, to compensate for the evaporated moisture, water (25° C.) was added to the dispersion liquid until the mass of the small pot whose tare was subtracted reached 500 g, and the mixture was entirely uniformly stirred. 100 mL of the obtained dispersion liquid was poured into a 100 mL graduated cylinder, the opening of the graduated cylinder was sealed, followed by allowing the graduated cylinder to stand at 25° C. for 24 hours. The boundary between the turbid part containing the wheat flour and the other transparent part of the dispersion liquid after 24 hours was visually measured, and the volume of each part was measured. The dispersibility of the dispersion liquid was calculated based on the following equation.

Dispersibility (%)=volume of turbid part (mL)/100 mL×100

### Test Example 1

1. Production of Modified Wheat Flours

Heat treated wheat flours were produced by the following procedure. A soft wheat flour having a moisture content of 13 mass % (manufactured by Nisshin Foods Inc.) (degree of gelatinization: 4) was used as the raw material wheat flour.

### Production Examples 1 to 3

The raw material wheat flour was heated using a sealed heated mixing apparatus (rocking dryer manufactured by AICHI ELECTRIC CO., LTD.) under the following conditions: at 90° C. for 60 minutes (Production Example 1), at 110° C. for 30 minutes (Production Example 2), or at 130° C. for 60 minutes (Production Example 3). The moisture content of each wheat flour after the end of heating was about 12 mass % and the degree of gelatinization thereof was in a range from 9 to 12. The viscosity and the dispersibility of each wheat flour after heating were measured by the method of Reference Example 1.

### Comparative Production Examples 1 to 2

The raw material wheat flour was accommodated in a retort pouch bag to have a plate shape having a thickness of about 5 mm, and the opening thereof was sealed, followed by heating at 60° C. for 1 minute (Comparative Production Example 1) or 6 minutes (Comparative Production Example 2). The moisture content of each wheat flour after heating was 13 mass % and the degree of gelatinization thereof was in a range from 4 to 6. The viscosity and the dispersibility of each wheat flour after heating were measured by the method of Reference Example 1.

### Comparative Production Examples 3 to 4

15 mass % of water with respect to the mass of the wheat flour was added to the raw material wheat flour, and the mixture was sealed in a heat-resistant sealed container. This container was heated in an oil bath at 110° C. for 2 minutes (Comparative Production Example 3) or at 110° C. for 30 minutes (Comparative Production Example 4). The moisture content of each wheat flour after heating was 27 mass % and the degree of gelatinization thereof was 60 or more. The viscosity and the dispersibility of each wheat flour after heating were measured by the method of Reference Example 1.

### Comparative Production Example 5

The raw material wheat flour was put in a small pot, and the pot was placed on an electric stove and stirred for 30 minutes so as not to burn the wheat flour while heating at about 120° C. The moisture content in the wheat flour after heating was 4 mass % and the degree of gelatinization thereof was 9. The viscosity and the dispersibility of the wheat flour after heating were measured by the method of Reference Example 1.

Table 1 shows the heating conditions and properties of the modified wheat flours produced. Table 1 also shows the properties of the raw material wheat flour as a reference.

TABLE 1

| | Production | | | Comparative | | | | | |
|---|---|---|---|---|---|---|---|---|---|
| | Example | | | Production Example | | | | | |
| | 1 | 2 | 3 | 1 | 2 | 3 | 4 | 5 | Reference |
| Heating | | | | | | | | | |
| Temperature (° C.) | 90 | 110 | 130 | 60 | 60 | 110 | 110 | 120 | — |
| Time (minutes) | 60 | 30 | 60 | 1 | 6 | 2 | 30 | 30 | — |
| Modified wheat flour | | | | | | | | | |
| Moisture content (%) | 12 | 12 | 12 | 13 | 13 | 27 | 27 | 4 | 13 |
| Viscosity (mPa · s) | ≤10 | ≤10 | ≤10 | 3570 | 3750 | 2630 | 4390 | 1200 | 3230 |
| Dispersibility (%) | 75 | 66 | 62 | 100 | 100 | 100 | 100 | 80 | 100 |

2. Production of Tonkatsu

Each dusting flour composition containing the modified wheat flour obtained in the above 1. was prepared with the composition shown in Table 2. The raw material wheat flour used in the above 1. was used as the untreated wheat flour. The composition was evenly attached to the whole surface of pork loin (thickness: 1 cm, 200 g). After 30 mass % of soft wheat flour, 10 mass % of whole egg, and 60 mass % of cold water were mixed to prepare batter liquid and the meat to which the composition had been attached was dipped in this batter liquid, bread crumbs were coated thereon, and the meat was deep-fried in oil at 170° C. for 4 minutes to produce tonkatsu. The tonkatsu produced was slightly cooled, stored in a refrigerator for 6 hours and then stored at room temperature (about 25° C.) for 1 hour. The tonkatsu after storage was cut with a knife and the attachability of the coating at that time was evaluated. Also, the texture of the coating when the tonkatsu after storage was eaten was evaluated. The evaluation was carried out by 10 professional panelists based on the following evaluation criteria and mean values of the evaluation results of 10 panelists were determined. The results are shown in Table 2.

Evaluation Criteria

[Attachability of Coating]

5: When tonkatsu is cut with a knife, no coating is peeled off, very good.

4: When tonkatsu is cut with a knife, almost no coating is peeled off, good.

3: When tonkatsu is cut with a knife, the coating is peeled off at a portion equivalent to from 10 to 20% of the whole circumference of the coating in the cross section.

2: When tonkatsu is cut with a knife, the coating is peeled off at a portion equivalent to more than 20% and 50% or less of the whole circumference of the coating in the cross section, poor.

1: When fried food is cut with a knife, the coating is peeled off at a portion equivalent to more than 50% of the whole circumference of the coating in the cross section, very poor.

[Texture of Coating]

5: Crispy and rich in brittleness, very good.

4: Crispy, good.

3: Slightly lack in crispness.

2: Slightly moist or slightly tacky, lack in crispness.

1: Moist or strongly tacky, no crispness, poor.

TABLE 2

| | | | | | | | | | | | Reference |
|---|---|---|---|---|---|---|---|---|---|---|---|
| | Example composition | | | | Comparative Example composition | | | | | | composition |
| Composition (mass %) | 1 | 2 | 3 | 4 | 1 | 2 | 3 | 4 | 5 | 6 | 1 |
| Modified wheat flour | | | | | | | | | | | |
| Production Example 1 | 20 | | | | | | | | | | |
| Production Example 2 | | 20 | | | | | | | | | |
| Production Example 3 | | | 20 | 10 | | | | | | | |
| Comparative | | | | 10 | 20 | | | | | 10 | |
| Production Example 1 | | | | | | | | | | | |
| Comparative | | | | | | 20 | | | | | |
| Production Example 2 | | | | | | | | | | | |
| Comparative | | | | | | | 20 | | | | |
| Production Example 3 | | | | | | | | | | | |
| Comparative | | | | | | | | 20 | | | |
| Production Example 4 | | | | | | | | | | | |
| Comparative | | | | | | | | | 20 | 10 | |
| Production Example 5 | | | | | | | | | | | |
| Untreated wheat flour | Balance | Balance | Balance | Balance | Balance | Balance | Balance | Balance | Balance | Balance | 100 |
| Total | 100 | 100 | 100 | 100 | 100 | 100 | 100 | 100 | 100 | 100 | 100 |
| Evaluation | | | | | | | | | | | |
| Texture of coating | 4.0 | 4.5 | 4.5 | 4.2 | 2.7 | 2.7 | 3.3 | 3.4 | 3.2 | 3.3 | 1.5 |
| Meltability of | 4.2 | 4.5 | 4.3 | 4.2 | 2.4 | 2.5 | 2.7 | 2.5 | 3.0 | 2.9 | 2.0 |
| coating in mouth | | | | | | | | | | | |

### Test Example 2

Each modified wheat flour was produced in a similar procedure as in Production Example 1 of Test Example 1 except that the heating temperature and time were variously changed as shown in Table 3, and the viscosity and the dispersibility were measured using the method of Reference Example 1. Each dusting flour composition was prepared using each obtained modified wheat flour with a similar composition as Example composition 1 of Test Example 1. Each tonkatsu was produced using each obtained batter in a similar procedure as in Test Example 1 and evaluated. The results are shown in Table 3.

TABLE 3

| | | | | | | | Comparative | |
|---|---|---|---|---|---|---|---|---|
| | Example composition | | | | | | Example composition | |
| | 5 | 6 | 7 | 8 | 9 | 10 | 7 | 8 |
| Modified wheat flour | | | | | | | | |
| Heating | | | | | | | | |
| Temperature (° C.) | 130 | 110 | 110 | 90 | 90 | 90 | 90 | 130 |
| Time (minutes) | 50 | 24 | 21 | 30 | 22 | 15 | 9 | 9 |
| Moisture content (%) | 12 | 12 | 12 | 12 | 13 | 13 | 13 | 13 |
| Viscosity (mPa · s) | ≤10 | 220 | 440 | 660 | 790 | 950 | 980 | 1240 |
| Dispersibility (%) | 52 | 68 | 78 | 80 | 80 | 88 | 92 | 87 |
| Composition of composition | | | | | | | | |
| (mass %) | | | | | | | | |
| Modified wheat flour | 20 | 20 | 20 | 20 | 20 | 20 | 20 | 20 |
| Untreated wheat flour | Balance | Balance | Balance | Balance | Balance | Balance | Balance | Balance |
| Total | 100 | 100 | 100 | 100 | 100 | 100 | 100 | 100 |
| Evaluation | | | | | | | | |
| Texture of coating | 4.6 | 4.3 | 4.0 | 4.0 | 4.0 | 3.9 | 2.9 | 3.4 |
| Meltability of coating in mouth | 4.4 | 4.3 | 4.1 | 4.0 | 3.9 | 3.9 | 2.8 | 3.3 |

### Test Example 3

Each dusting flour composition with the composition as shown in Table 4 was prepared, and using them, each tonkatsu was produced in a similar procedure as in Test Example 1 and evaluated. The results are shown in Table 4.

TABLE 4

| | Comparative | | | | | | | | |
|---|---|---|---|---|---|---|---|---|---|
| | Example | | | | | | | | |
| | composition | Example composition | | | | | | | |
| Composition (mass %) | 9 | 11 | 12 | 13 | 3 | 14 | 15 | 16 | 17 |
| Production Example 3 | 3 | 5 | 10 | 15 | 20 | 25 | 30 | 40 | 60 |
| Untreated wheat flour | Balance | Balance | Balance | Balance | Balance | Balance | Balance | Balance | Balance |
| Total | 100 | 100 | 100 | 100 | 100 | 100 | 100 | 100 | 100 |
| Evaluation | | | | | | | | | |
| Attachability of coating | 2.2 | 3.6 | 3.9 | 4.2 | 4.5 | 4.5 | 4.3 | 4.1 | 3.9 |
| Texture of coating | 2.5 | 3.9 | 4.1 | 4.2 | 4.3 | 4.1 | 3.8 | 3.5 | 3.3 |

### Test Example 4

Each dusting flour composition with the composition as shown in Table 5 was prepared, and using them, each tonkatsu was produced in a similar procedure as in Test Example 1 and evaluated. The results are shown in Table 5.

TABLE 5

| | Example composition | | | | | | | | |
|---|---|---|---|---|---|---|---|---|---|
| Composition (mass %) | 3 | 18 | 19 | 20 | 21 | 22 | 23 | 24 | 25 |
| Production Example 3 | 20 | 20 | 20 | 20 | 20 | 20 | 20 | 20 | 20 |
| Potato starch | | 20 | 50 | | | | 20 | | |
| Corn starch | | | | 20 | | | | | |
| Rice flour | | | | | 20 | | | | |
| Barley flour | | | | | | 20 | | | |
| Dextrin | | | | | | | 20 | 20 | 80 |
| Untreated wheat flour | Balance | Balance | Balance | Balance | Balance | Balance | Balance | Balance | — |
| Total | 100 | 100 | 100 | 100 | 100 | 100 | 100 | 100 | 100 |
| Evaluation | | | | | | | | | |
| Attachability of coating | 4.5 | 4.7 | 4.8 | 4.7 | 4.6 | 4.6 | 4.6 | 4.3 | 3.7 |
| Texture of coating | 4.3 | 4.5 | 4.6 | 4.6 | 4.8 | 4.6 | 4.6 | 4.2 | 3.2 |

1. A dusting flour composition, comprising:
5 mass % or more of a modified wheat flour,
wherein a viscosity of a 10 mass % aqueous suspension of the modified wheat flour is 1,000 mPa·s or less when the aqueous suspension is warmed to 85° C. and then cooled to 25° C., and
wherein a dispersibility of the aqueous suspension is 90% or less when the aqueous suspension is warmed to 85° C., then cooled to 25° C., and subsequently allowed to stand for 24 hours.

2. The composition of claim 1, wherein the aqueous suspension has a viscosity of 800 mPa-s or less and a dispersibility of 10 to 80%.

3. The composition of claim 1, wherein a moisture content of the modified wheat flour is from 10 to 14 mass %.

4. The composition of claim 1, wherein a degree of gelatinization of the modified wheat flour is 12% or less.

5. The composition of claim 1, wherein the composition comprises
from 5 to 30 mass % of the modified wheat flour, and
one or more selected from the group consisting of cereal flours other than the modified wheat flour and starches.

6. A method for producing a fried food product, the method comprising attaching the dusting flour composition according to of claim 1 to a food ingredient, subsequently attaching batter to the food ingredient, and then frying the food ingredient.

7. (canceled)
